(19) United States
(12) Patent Application Publication
(10) Pub. No.: US 2010/0191834 A1
(43) Pub. Date: Jul. 29, 2010

(54) Method and system for containing routes

(76) Inventor: Geoffrey Zampiello, Norwalk, CT (US)

Correspondence Address: AT&T Legal Department - HFZ;ATTN. Patent Docketing, One AT&T Way, Room 2A-207, Bedminstor, NJ, 07921, US

(21) Appl. No.: 12/321,899

(22) Filed: Jan. 27, 2009

(51) Int. Cl. G06F 15/173; G06F 15/177

(52) U.S. Cl. 709/220; 709/238

(57) ABSTRACT

A system and method for limiting network access for a network subscriber based on limited network routing defined within at least one data container is disclosed. The system includes at least one network server adapted for receiving a request for network access and checking whether the network subscriber is identified in at least one data container having an approved route list comprising at least one permissible route for the subscriber; and if the network subscriber is part of the data container, limiting network access for the network subscriber to the at least one permissible route by provisioning at least one router in the network to limit routing requests from the subscriber to the approved route list.

### FIELD OF THE INVENTION

The present invention relates generally to communications networks, and more particularly, to a system and method for limiting a subscriber's network access to specific routes identified in at least one data container associated with the subscriber.

### BACKGROUND OF THE INVENTION

In the relatively short span of about two decades, the Internet, a network of networked computing devices, has revolutionized personal, corporate, educational and government communications. The technological ability to provide almost unlimited information and content to users provides both opportunities and challenges to those wishing to control content accessibility. For example, in the personal computing environment, parents may wish to restrict their children from being able to access media having certain content, game rating restrictions or from being able to access certain services altogether. In a corporate or governmental computing environment, network administrators may wish to restrict their users from being able to access inappropriate content, such as adult content, hate group content or other content inconsistent or offensive to their organizational goals or documented policies. In an educational computing environment, network administrators may wish to restrict their users to only content with has been approved, for example by a school board, determined in part by the user's age or grade level.

A variety of methods are currently employed by network administrators to control network access. Web browsers such as Internet Explorer® 7.0 (IE7) and Firefox®, operating systems such as Windows® Vista, and stand alone filtering software such as CyberPatrol® and NetNanny™ offer varying levels of built-in access control functionality, all of which have their attendant benefits and drawbacks.

For example, IE7 enables an administrator utilizing an administrator password to establish, modify or eliminate the user-specific restrictions and controls. FIG. 1a is a depiction of IE7 that shows the Internet Options/Content tab where parental controls and content advisor parameters can be modified. By clicking on the Parental Controls button 102, specific controls can be established for each user. This can include restricting websites that users can visit, restrict file downloads and setup which content the content filters will block or allow, restrict log on times and automatically log off at a specific time, restrict games based on ratings or not allow unrated games to play, and allow or block specific programs. By clicking the Content Advisor Enable button 104, of FIG. 1a, the Window of FIG. 1b opens to the Ratings tab. This window allows user-specific settings for content, for example “Content that creates fear, intimidation, etc.” 106, which can be set to levels of either None 108, where no content of this type is allowed, Limited 110 or Unrestricted 112 by adjusting the slider accordingly. By clicking the Approved Sites tab of the Content Advisor window shown in FIG. 1b, the window shown in FIG. 1c is generated, where the summarized list of approved and disapproved websites (list 116) is shown for each user. Inclusion, modification and removal of sites from list 116 may be implemented by entering the website into the “Allow this website” (114) area and clicking the appropriate button (118). Once all the user-specific settings are saved, the settings are then enforced until they are modified or eliminated by the administrator.

While the prior art provides methodologies for limiting unlimited network access to certain sites, none of these implementations are adapted to provide only limited access to specified sites at the level of the network service provider.

It would therefore be desirable to provide a system and methodology for enabling a network service provider to offer subscription packages for a given subscriber that limits the subscriber to selected routes that are part of the package.

### SUMMARY OF THE INVENTION

In accordance with aspects of the invention, there is provided a system and method for limiting network access for a network subscriber based on limited network routing defined within at least one data container. The system includes at least one network server adapted for receiving a request for network access and checking whether the network subscriber is identified in at least one data container having an approved route list comprising at least one permissible route for the subscriber; and if the network subscriber is part of the data container, limiting network access for the network subscriber to the at least one permissible route by provisioning at least one router in the network to limit routing requests from the subscriber to the approved route list.

In accordance with the invention, network subscribers are assigned to the at least one data container and permitted routes are defined in accordance with a subscription agreement for the network subscribers. Each data container may include a plurality of subscribers and permitted routes for that group of subscribers, or may associate an individual subscriber with permitted routes for that subscriber only.

The containers may be created and modified by a network administrator, or alternatively, by the network subscriber through a web interface.

Each container may be constructed with links to at least one sub-container that further comprises additional route limitations for the network subscriber.

In an exemplary embodiment, network access for the network subscriber is limited to the at least one permissible route by associating an IP address allocated to the subscriber with the approved route list in the at least one container.

These aspects of the invention and further advantages thereof will become apparent to those skilled in the art as the present invention is described with particular reference to the accompanying drawings.

### BRIEF DESCRIPTION OF THE DRAWINGS

FIGS. 1a, 1b and 1c depict prior art parental controls and content adviser parameters in Internet Explorer 7;

FIG. 2 is a high-level network diagram of a system for carrying out aspects of the present invention;

FIG. 3 is an exemplary container structure in accordance with an aspect of the invention;

FIG. 4 is another exemplary container structure in accordance with an aspect of the invention;

FIG. 5 is a schematic of a container administrator module in accordance with an aspect of the invention; and

FIG. 6 is high-level flow diagram of a process for limiting network access in accordance with an aspect of the invention.

### DETAILED DESCRIPTION OF THE INVENTION

Embodiments of the invention will be described with reference to the accompanying drawing figures wherein like numbers represent like elements throughout to the extent possible. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein are meant to encompass the items listed thereafter and equivalents thereof as well as additional items.

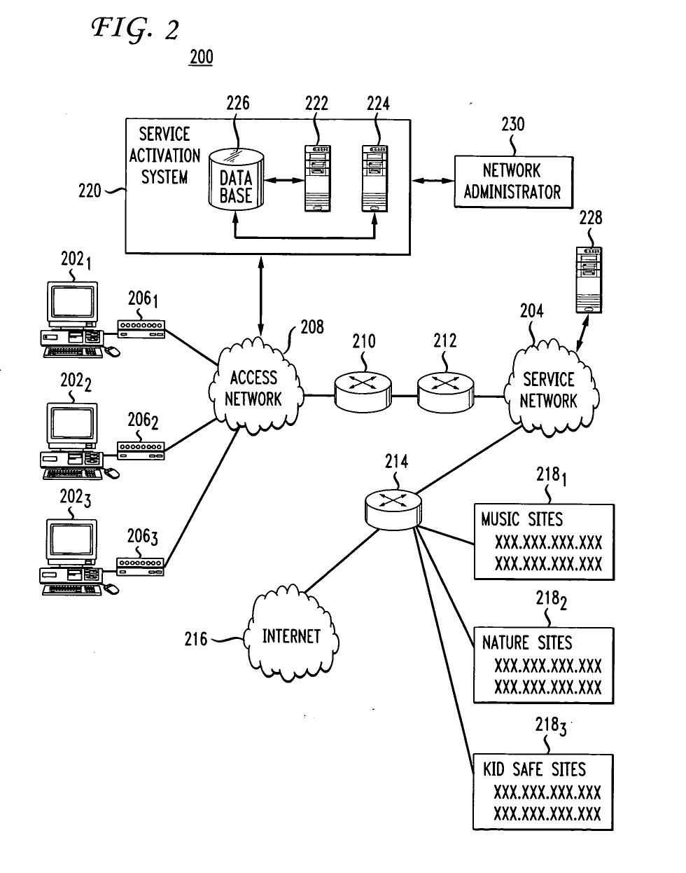

FIG. 2 is a schematic of a plurality of subscribers operating network access devices (NADs) 202₁, 202₂, 202₃ for accessing a packet-switched data network 204 referred to hereinafter as a “service network.” The service network 204, as is well known in the art, utilizes a network addressing scheme to route datagrams to and from hosts: for example, where the service networks utilize the TCP/IP protocol suite, Internet Protocol (IP) addresses are assigned to each host and utilized in the process of routing packets from a source to a destination in the networks. See, e.g., “INTERNET PROTOCOL,” IETF Network Working Group, RFC 791 (September 1981); S. Deering, R. Hinden, “Internet Protocol, Version 6 (IPv6) Specification,” IETF Network Working Group, RFC 1883 (December 1995), which are incorporated by reference herein. The invention shall be described herein with particular reference to the TCP/IP protocol suite and IP addresses, although those skilled in the art would readily be able to implement the invention using any of a number of different communication protocols.

The network access devices 202₁, 202₂, 202₃ are typically customer premises equipment (CPE) such as a personal computer, information appliance, personal data assistant, data-enabled wireless handset, or any other type of device capable of accessing information through a packet-switched data network. Each network access device 202₁, 202₂, 202₃ is either connected to or integrated with a network interface unit 206₁, 206₂, 206₃, e.g. a modem, which enables communication through an access network infrastructure, generally characterized by the reference numeral 208. Each network access device is assigned an IP address associated with a service provider to which the user of the device is subscribed. For the examples described herein, a single service network 204 is shown, but the methodology in accordance with the present invention may be implemented by multiple service providers as will be appreciated by those skilled in the art.

The access network infrastructure 208 advantageously can be operated and maintained by an entity that is the same as or different from the entities operating and maintaining the service networks 204. In accordance with an embodiment of an aspect of the present invention, layer three routing procedures are modified to permit IP traffic from a network access device 202 to flow only to and from specified sites/servers in accordance with the subscriber's subscription agreement with the service provider.

The access network 208 has a router 210 on the edge of the access network, which has an interface with a connection to a router 212 in service network 204. Other interfaces (not shown) associated with router 210 can provide a connection to other service networks (not shown). The service network 204 includes a router 214 that provides general connectivity to the Internet 216 as well as limited access only to specified sites, e.g., 218₁, 218₂, 218₃ based on limited routes that are embodied in a container in accordance with an aspect of the present invention as will be described in greater detail below.

IP addresses for the NADs may be assigned dynamically as is well known in the art. A service activation system 220 is coupled to the access network 208 and comprises a configuration server 222 and a registration server 224. The registration server 224 provides a network-based subscription/authorization process for the various services shared on the access network infrastructure 208. A customer desiring to subscribe to a service with service network 204 can access and provide registration information to the registration server 224, e.g. by using HTML forms and the Hyper Text Transfer Protocol (HTTP) as is known in the art. Upon successful service subscription, the registration server 224 updates a customer registration database 226 which associates the customer information including the customer's hardware address (e.g., the MAC address of the NAD 202) with the subscribed service.

The configuration server 222 uses the registration information to activate the service. The configuration server 222 is responsible for allocating network addresses on behalf of the service network 208 from a network address space associated with the selected service. In an illustrative embodiment, the configuration server 222 uses a host configuration protocol such as the Dynamic Host Configuration Protocol (DHCP) to configure the network addresses of the NADs. See R. Droms, “Dynamic Host Configuration Protocol,” IETF Network Working Group, RFC 2131 (March 1997); S. Alexander, R. Droms, “DHCP Options and BOOTP Vendor Extensions,” IETF Network Working Group, RFC 2132 (March 1997); which are incorporated by reference herein. This configuration server 222 shall therefore be referred to herein as the DHCP server, although those skilled in the art would readily be able to implement this aspect of the invention using a different protocol.

The operator of the service network 208 may desire to maintain a separate registration server, e.g. 228, and to retain responsibility for user authentication and authorization. The service activation system 220 can provide a proxy server configured to permit HTTP traffic only between local hosts and registration server 228 in service network 204. The service provider operating service network 204 would then be responsible for providing the appropriate registration information required for proper service selection to the service activation system 220. Alternatively, the DHCP server 222 in the service activation system 220 can interact with the registration server 228 using a back-end authentication protocol, e.g. the Remote Authentication Dial In User Service (RADIUS). See C. Rigney, A. Rubens, W. Simpson, S. Willens, “Remote Authentication Dial In User Service (RADIUS),” IETF Network Working Group, RFC 2058 (January 1997), which is incorporated by reference herein. The DHCP server can contain a RADIUS client and, thereby, leverage the large RADIUS embedded base used for dial access authentication.

In accordance with an aspect of the invention, the configuration server 222 has access to or otherwise maintains a plurality of data containers for subscribers to the service provider network 204. When a subscriber logs onto his or her service network 208, the configuration server 222 checks whether the subscriber is part of a container. The containers may be modified by a network administrator generally characterized by the reference numeral 230, or by the subscriber itself in certain embodiments as described below. The containers are utilized to limit the subscriber's network access to routes defined in the containers.

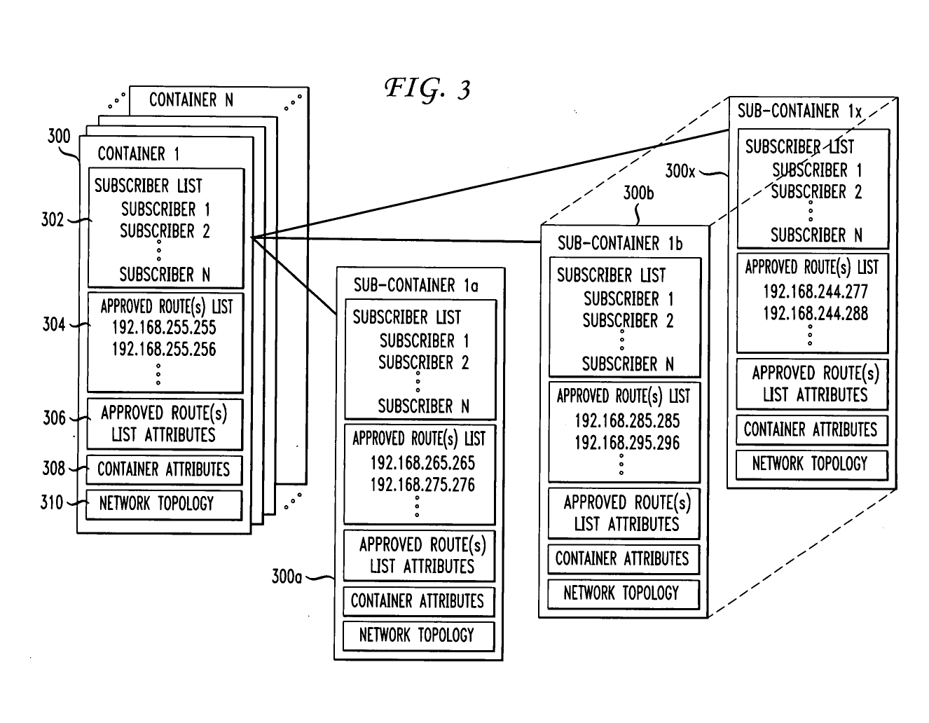

FIG. 3 depicts an exemplary data container structure 300 in accordance with the present invention. As will be appreciated by those skilled in the art, the container is constructed as a class, a data structure, or an abstract data type whose instances are collections of other objects. Containers can be used to store objects in an organized way following specific access rules, and in the context of the present invention are used for two purposes, to: (1) define the member (or members) of a subscriber group and (2) define allowable routes on a network that the subscriber(s) will have access to.

The container can be utilized to group a plurality of network service subscribers or to associate a single subscriber with a specific set of permitted routes. As shown in FIG. 3, an exemplary container 300 for multiple subscribers comprises a subscriber list 302 and the approved route(s) list 304, i.e., a routing table that is specific to the container. The approved route list 304 in this instance depicts a plurality of routes identified by blocks of IP addresses that a subscriber or group of subscribers associated with container 300 has access to in accordance with the terms of a subscription agreement. For example, a subscriber may desire to have limited network access to particular sites such as music sites, nature sites, kid-safe sites and/or the like. The route list 304 therefore can be any number of individual routes or ranges of routes that correspond to these sites. Container 300 further comprises an approved routes list attributes block 306 and container attributes block 308 for facilitating management by an administrator of the subscriber list 302 and approved routes list 304. The container attributes block may include data for linking the container to sub-containers 300a, 300b, . . . 300x that may include further route privileges for the subscribers identified in the root container 300. Each sub-container can also have further “children” associated therewith as required to define a desired set of permitted routes for the subscribers in container 300. Container 300 also includes a network topology block 310 for identifying and provisioning the service network router(s) such that subscribers identified with a particular container's routes are limited to those routes.

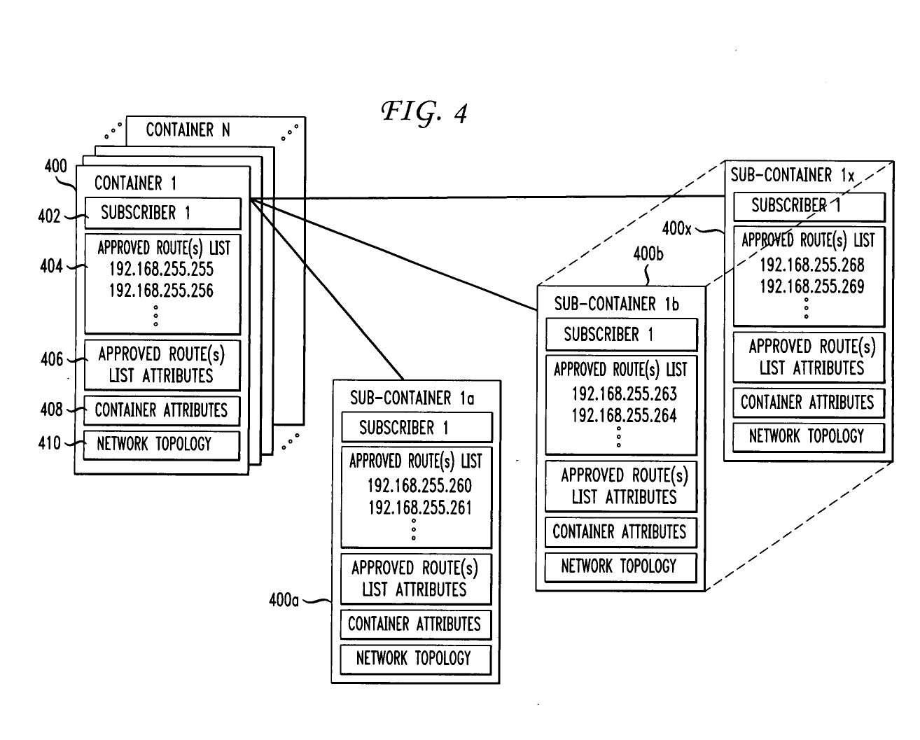

FIG. 4 is an alternative data container structure 400 wherein each container is uniquely associated with a particular subscriber and accordingly includes route access privileges only for that subscriber. The general configuration is the same as that shown in FIG. 3, including a subscriber block 402, approved route(s) list 404, approved route list attribute block 406, container attribute block 408 and network topology block 410. The container 400 may also be linked to sub-containers 400a, 400b, . . . 400x.

The present invention may be implemented by program modules that are executed by a computer. Generally, program modules include routines, objects, components, data structures and the like that perform particular tasks or implement particular abstract data types. The term “program” as used herein may connote a single program module or multiple program modules acting in concert. The invention may be implemented on a variety of types of computers, including personal computers (PCs), hand-held devices, multi-processor systems, microprocessor-based programmable consumer electronics, network PCs, minicomputers, mainframe computers and the like. The invention may also be employed in distributed computing environments, where tasks are performed by remote processing devices that are linked through a communications network. In a distributed computing environment, modules may be located in both local and remote memory storage devices.

In one embodiment, the invention is directed toward one or more computer systems capable of carrying out the functionality described herein. An exemplary computer system of the type known in the art includes one or more processors connected to a communication infrastructure (e.g., a communications bus, cross-over bar, or network). The computer system can include a display interface (e.g. a graphics card) that allows graphics, text, and other data from the communication infrastructure or from a frame buffer to be displayed on a display unit. The computer system also includes a main memory, preferably random access memory (RAM), and may also include a secondary memory. The secondary memory may include, for example, a hard disk drive and/or a removable storage drive. The removable storage drive has read/write functionality onto removable storage media having stored therein computer software and/or data. In alternative embodiments, secondary memory may include other similar devices for allowing computer programs or other instructions to be loaded into the computer system. Such devices may include, for example, a removable storage unit and an interface. Examples of such may include a program cartridge and cartridge interface (such as that found in video game devices), a removable memory chip (such as an erasable programmable read only memory (EPROM)), or programmable read only memory (PROM)) and associated socket, and other removable storage units and interfaces, which allow software and data to be transferred from the removable storage unit to the computer system. The computer system may also include a communications interface allowing software and data to be transferred between computer system and external devices. Examples of a communications interface may include a modem, a network interface (such as an Ethernet card), a communications port, a Personal Computer Memory Card International Association (PCMCIA) slot and card, etc. Software and data transferred via the communications interface are in the form of signals which may be electronic, electromagnetic, optical or other signals capable of being received by the communications interface. These signals are provided to communications interface via a communications path or channel, which carries the signals and may be implemented using wire or cable, fiber optics, a telephone line, a cellular link, a radio frequency (RF) link and/or other communications channels. Computer programs (also referred to as computer control logic) are stored in a main memory and/or secondary memory. Computer programs may also be received via the communications interface. Computer programs, when executed, enable the computer system to perform the features of the present invention, as discussed herein. Accordingly, such computer programs represent controllers of the computer system. In an embodiment where the invention is implemented using software, the software may be stored in a computer program product and loaded into the computer system using a removable storage drive, hard drive, or communications interface. The control logic (software), when executed by the processor causes the processor to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s). In one exemplary embodiment, the system for the present invention may be implemented, for example, as a Microsoft.net® desktop application program (Microsoft.net® is made by Microsoft® Corporation of Redmond, Wash.), which may reside on a computer hard drive, database or other repository of data, or be uploaded from the Internet or other network (e.g., from a PC, minicomputer, mainframe computer, microcomputer, telephone device, PDA, or other network device having a processor and input and/or output capability). Any available software tool capable of implementing the concepts described herein may be used to implement the system and method of the present invention. The method and system of the present invention may also be implemented as an application-specific add-on to a program, or as a standalone application.

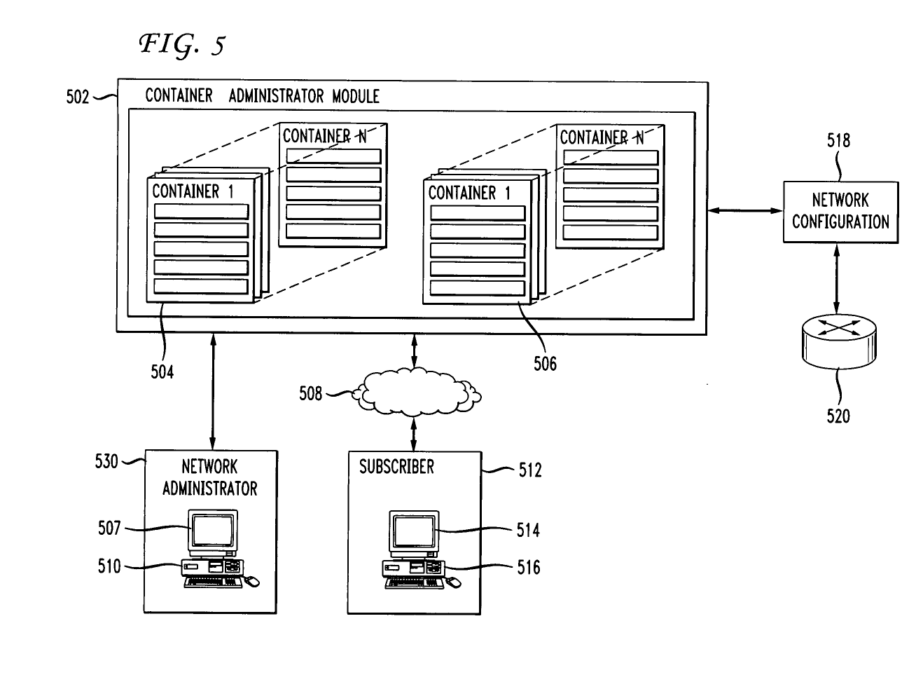

FIG. 5 is a high level schematic of a system 500 that includes one or more program modules to carry out the functionality of the present invention. The system includes a container administrator module 502 that may be part of the configuration server 222 of the service activation system 220 (FIG. 2) or alternatively, this may reside on a separate system that is accessible by the service activation system 220. The container administrator module 502 includes a plurality of containers 504, where each module associates multiple subscribers with a set of approved routes for those subscribers as described above with reference to FIG. 3, and a plurality of containers 506 that associate individual subscribers with a set of approved routes as shown in FIG. 4. A network administrator 530 (corresponding to 230 in FIG. 2) can edit the contents of containers 504 through a graphical user interface 507 on a computer shown generally at 510. The network administrator can catalog and enter the IP addresses for permitted routes that are part of a container package for a group of subscribers in containers 504, or for individual subscriber in containers 506. Permitted routes for each subscriber can be added and/or removed from each container by editing the contents of the same via the graphical user interface 507. It will be appreciated by those skilled in the art that the network administrator may be associated with the service network, or alternatively, may be thought of as one who controls a company network and desires to limit a plurality of users under administrator control to specified routes on the Web. After a container(s) is modified by the network administrator, the new routing information is utilized to provision the router(s) in the service network so that the subscriber(s) may obtain limited network access as defined in the container(s). Methods for editing a data container are known in the art as evidenced by Dooley et al. U.S. Publ. No. 2006/0126636, published Jun. 15, 2006, the disclosure of which is incorporated by reference herein.

Alternatively, an individual subscriber 512 can subscribe to the service network for limited access and be granted a limited session through network 508 to enter his or her own set of approved routes via a graphical user interface 514 on a computer depicted generally at 516. The permissions as set forth in each container residing in the container administrator module 502 are communicated to a network configuration module 518 to provision a default router(s) 520 associated with the service network such that the subscribers are limited to those routes that are listed in the container(s) associated with their respective subscriptions with the service network. In this manner, a subscriber is provided with limited web access at the level of the service provider. Such access can be modified by either the network administrator or the subscriber in accordance with the terms of a subscription agreement. When administered by the service provider, the methodology afforded by the present invention in effect defines a service to which a user can subscribe to, based on a limited scope of allowable route(s). When administered by the subscriber, an aspect of the present invention can provide an element of parental control by limiting a network access device to, for example, “kid-safe” sites that are listed in a container associated with the subscription, or access control for an individual or a user group under the control of a network administrator such as in a personal, corporate, government or educational computing environment.

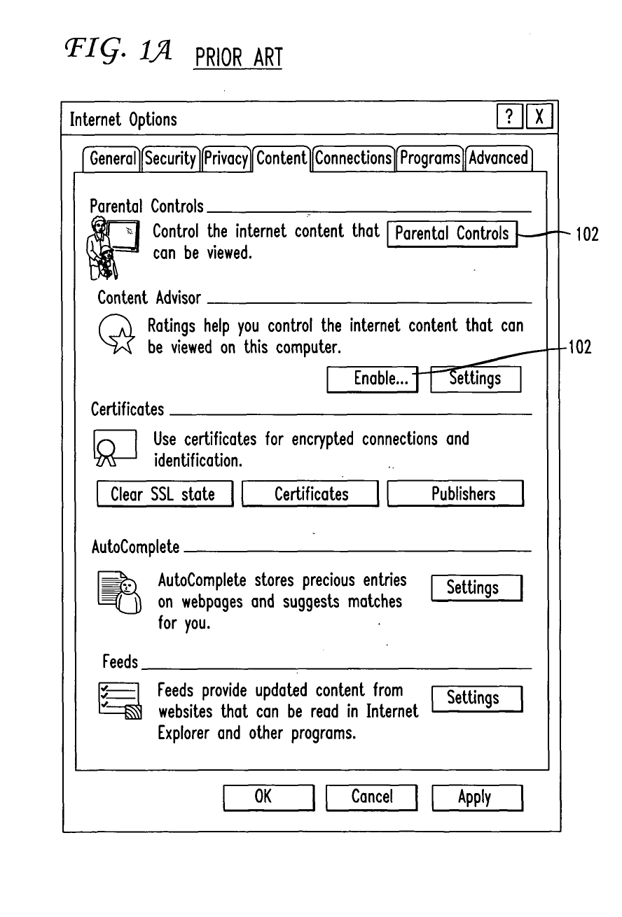

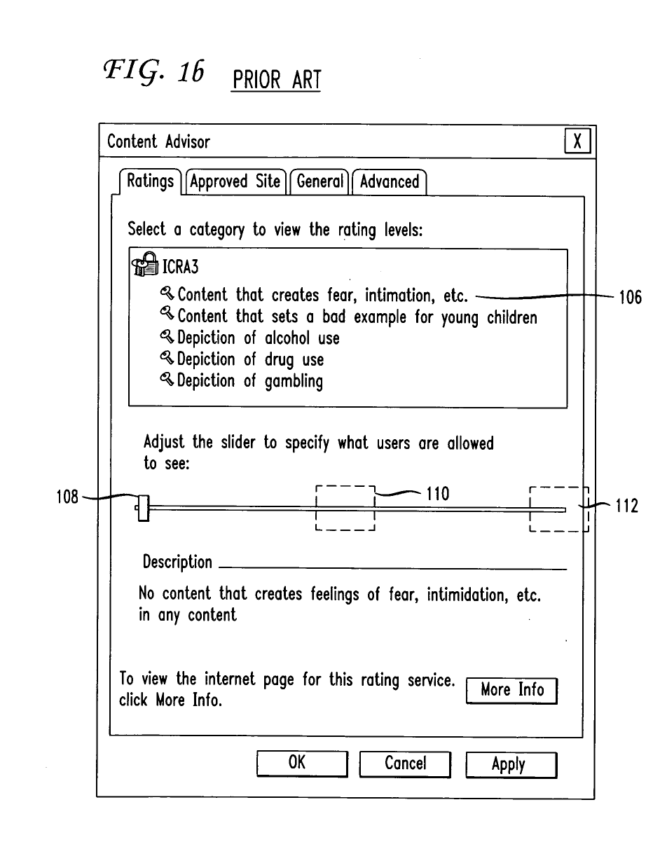

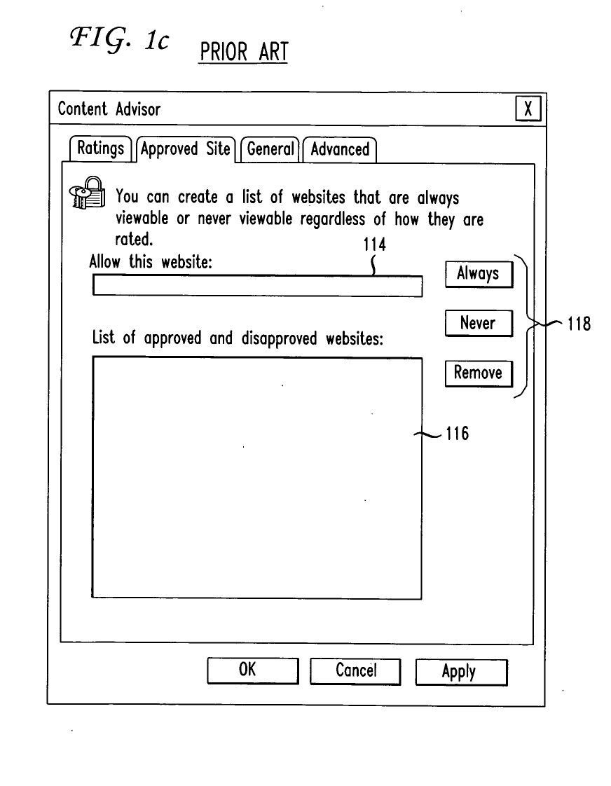

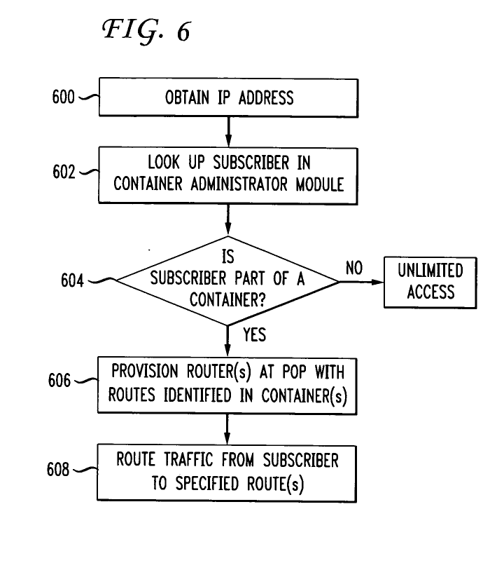

FIG. 6 is a high-level flow diagram of a method in accordance with an aspect of the present invention. It is assumed that subscribers have registered with the service network and subscribed to a service package with that network, either unlimited (regular Internet access), or in accordance with the invention, for a limited access package. In step 600, a subscriber connects to the service network (204 in FIG. 1) through an access network (208). In step 602, the service activation system (220) looks up the subscriber in the container administrator module (502, FIG. 5) and checks in step 604 whether the subscriber is part of a container. If the subscriber is not part of a container, but has regular unlimited access privileges, then at step 606 that subscriber is provided with an IP address that has unrestricted network access. If the subscriber is part of a container, then at step 606 the configuration server (222) network configuration module (518) in the service activation system (220) configures the router(s) at the point-of-presence (POP) for the subscriber such that only routes identified in the container(s) associated with that subscriber are accessible via the service network. This may be accomplished by provisioning the router(s) such that the source IP address assigned to the subscriber can only be directed to the unique routing table listed in the container(s) associated with the subscriber. It will be appreciated by those skilled in the art that the container(s) may be modified by the network administrator as discussed above to add or delete routing permissions at any time. Thus, if the container(s) for a subscriber requesting network access has changed since the last time the subscriber has requested network access, the router(s) are re-provisioned in accordance with the current container(s) structure at step 606. In step 608, a request from the subscriber through the service network is then limited to those routes specified in the subscriber's container(s). It will be appreciated by those skilled in the art that the use of linked containers as described with reference to FIGS. 3 and 4 may permit levels of access to linked material between authorized sites. For example, a primary container such as container 1 (300, FIG. 3) may have an approved routes or site list of “kid-safe” sites. The sub-container 1a (300a) may have a list of further sites that are linked in some way to those identified in the primary container (300).

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

I claim:

1. A method of limiting network access for a network subscriber, comprising:
in response to receiving a request for network access, checking whether the network subscriber is identified in at least one data container having an approved route list comprising at least one permissible route for the subscriber; and
if the network subscriber is part of the data container, limiting network access for the network subscriber to the at least one permissible route by provisioning at least one router in the network to limit routing requests from the subscriber to the approved route list.

2. The method of claim 1, wherein each data container associates a plurality of network subscribers with the approved route list.

3. The method of claim 1, wherein each data container associates a single network subscriber with the approved route list.

4. The method of claim 1, further comprising assigning the network subscriber to the at least one data container and defining the at least one permitted route in accordance with a subscription agreement for the network subscriber.

5. The method of claim 1, further comprising modifying the data container in response to inputs by the network subscriber who is identified in the data container.

6. The method of claim 1, wherein the data container is associated with a service activation system for the network.

7. The method of claim 1, wherein the data container includes links to at least one sub-container comprising further route limitations for the network subscriber.

8. The method of claim 1, wherein the limiting network access for the network subscriber to the at least one permissible route further comprises associating an IP address allocated to the subscriber with the approved route list in the at least one container.

9. A system for limiting network access for a network subscriber, comprising:
at least one network server adapted for receiving a request for network access and checking whether the network subscriber is identified in at least one data container having an approved route list comprising at least one permissible route for the subscriber; and
if the network subscriber is part of the data container, limiting network access for the network subscriber to the at least one permissible route by provisioning at least one router in the network to limit routing requests from the subscriber to the approved route list.

10. The system of claim 9, wherein each data container associates a plurality of network subscribers with the approved route list.

11. The system of claim 9, wherein each data container associates a single network subscriber with the approved route list.

12. The system of claim 9, wherein the at least one server is further adapted to assign the network subscriber to the at least one data container and defining the at least one permitted route in accordance with a subscription agreement for the network subscriber.

13. The system of claim 9, wherein the at least one server is further adapted to modify the data container in response to inputs by the network subscriber who is identified in the data container.

14. The system of claim 9, wherein the data container includes links to at least one sub-container comprising further route limitations for the network subscriber.

15. The system of claim 9, wherein the at least one server is adapted to associate an IP address allocated to the subscriber with the approved route list in the at least one container.
